(19) United States
(12) Patent Application Publication
(10) Pub. No.: US 2011/0216364 A1
(43) Pub. Date: Sep. 8, 2011

(54) RECEPTION NOTIFYING APPARATUS AND RECEPTION NOTIFYING METHOD

(75) Inventors: Michiaki Konno, Kanagawa-ken (JP); Jun Sasano, Tokyo-to (JP); Tomohide Oka, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/040,615

(22) Filed: Mar. 4, 2011

Related U.S. Application Data
(60) Provisional application No. 61/311,579, filed on Mar. 8, 2010.
(60) Provisional application No. 61/350,201, filed on Jun. 1, 2010.

(51) Int. Cl. G06F 15/00; G06F 17/30

(52) U.S. Cl. 358/1.15; 707/822; 707/E17.01

(57) ABSTRACT

According to one embodiment, a reception notifying apparatus includes a management unit, a reception unit, a processing unit, and a notification unit. The management unit manages notification party information used to give a notification of file reception. The reception unit receives a file. The processing unit processes the received file based on file control information attached to the received file. The notification unit gives a notification of the processing result of the received file based on the notification party information.

### CROSS-REFERENCE TO RELATED APPLICATIONS

This application is based upon and claims the benefit of priority from U.S. Provisional Applications No. 61/311,579, filed on Mar. 8, 2010; and No. 61/350,201, filed on Jun. 1, 2010; the entire contents of both of which are incorporated herein by reference.

### FIELD

Embodiments described herein relate generally to a reception notifying apparatus and a reception notifying method.

### BACKGROUND

Hereinbefore, there were suggested various types of file transmission apparatuses. For example, a file transmission apparatus receives files transmitted from a PC or the like via a network, instructs a designated storage apparatus to store the received files via the network, and transmits the received files to the designated storage apparatus. Thus, the files transmitted from the PC or the like can be stored in the designated storage apparatus via the network. Moreover, the file transmission apparatus receives the files transmitted from the PC or the like via the network, instructs a designated printer to print out the received files via the network, and transmits the received files to the designated printer. Thus, the files transmitted from the PC or the like via the network can be printed out by the designated printer.

In this case, an administrator who intends to store the files in the storage apparatus by use of the file transmission apparatus or an administrator who intends to cause the printer to print out the files by use of the file transmission apparatus gains access to the file transmission apparatus such as a PC and confirms a processing status of the files. However, such confirmation work is inconvenient.

### BRIEF DESCRIPTION OF THE DRAWINGS

FIG. 1 is a diagram illustrating an example of the overall configuration of a file transmission system according to a first embodiment.

FIG. 2 is a diagram illustrating an example of the overall configuration of a file transmission system according to a second embodiment.

FIG. 3 is a diagram illustrating an example of the overall configuration of a file transmission system according to a third embodiment.

FIG. 4 is a flowchart illustrating an example of a reception notifying process performed by the file transmission system according to the first embodiment.

FIG. 5 is a diagram illustrating an example of the overall configuration of each apparatus of the file transmission system according to the first embodiment.

FIG. 6 is a diagram illustrating an example of a setting screen of a transmission party designated folder.

FIG. 7 is a diagram illustrating an example of a notification screen of a processing result of a received file.

### DETAILED DESCRIPTION

In general, according to one embodiment, a reception notifying apparatus includes a management unit, a reception unit, a processing unit, and a notification unit. The management unit manages notification party information used to notify a transmission party of file reception. The reception unit receives the files. The processing unit processes the received file based on file control information attached to the received file. The notification unit notifies the transmission party of the processing result of the received file based on the notification party information.

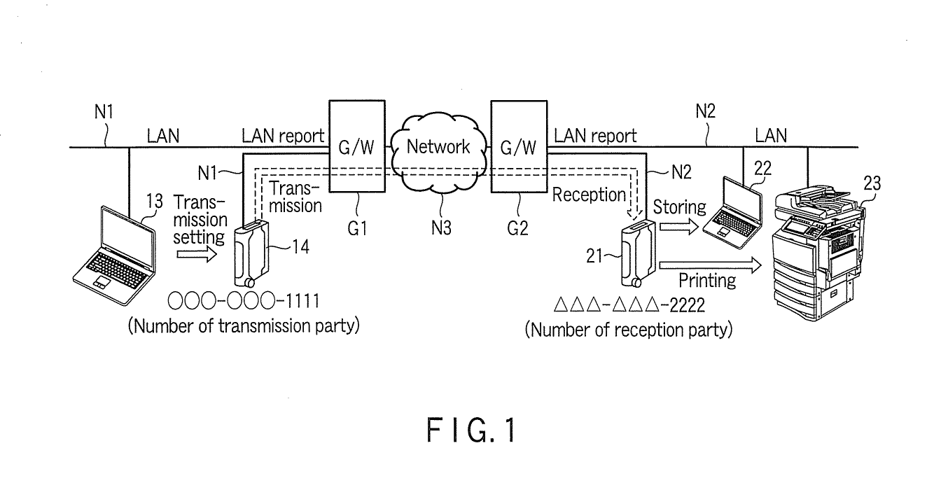

FIG. 1 is a diagram illustrating an example of the overall configuration of a file transmission system according to a first embodiment. As shown in FIG. 1, the file transmission system includes a communication apparatus 13, a transmission apparatus 14, a transmission apparatus 21, a storage apparatus 22, and an output apparatus 23. For example, the communication apparatus 13 and the storage apparatus 22 are computers. For example, the output apparatus 23 is an image forming apparatus.

The communication apparatus 13 and the transmission apparatus 14 are connected to each other via a first network N1 and the transmission apparatus 21, the storage apparatus 22, and the output apparatus 23 are connected to each other via a second network N2. The first network N1 and the second network N2 are connected to each other via various types of communication devices. For example, the first network N1 and the second network N2 are connected to each other via a gateway G1, a third network N3 (for example, an NGN (Next Generation Network), and a gateway G2.

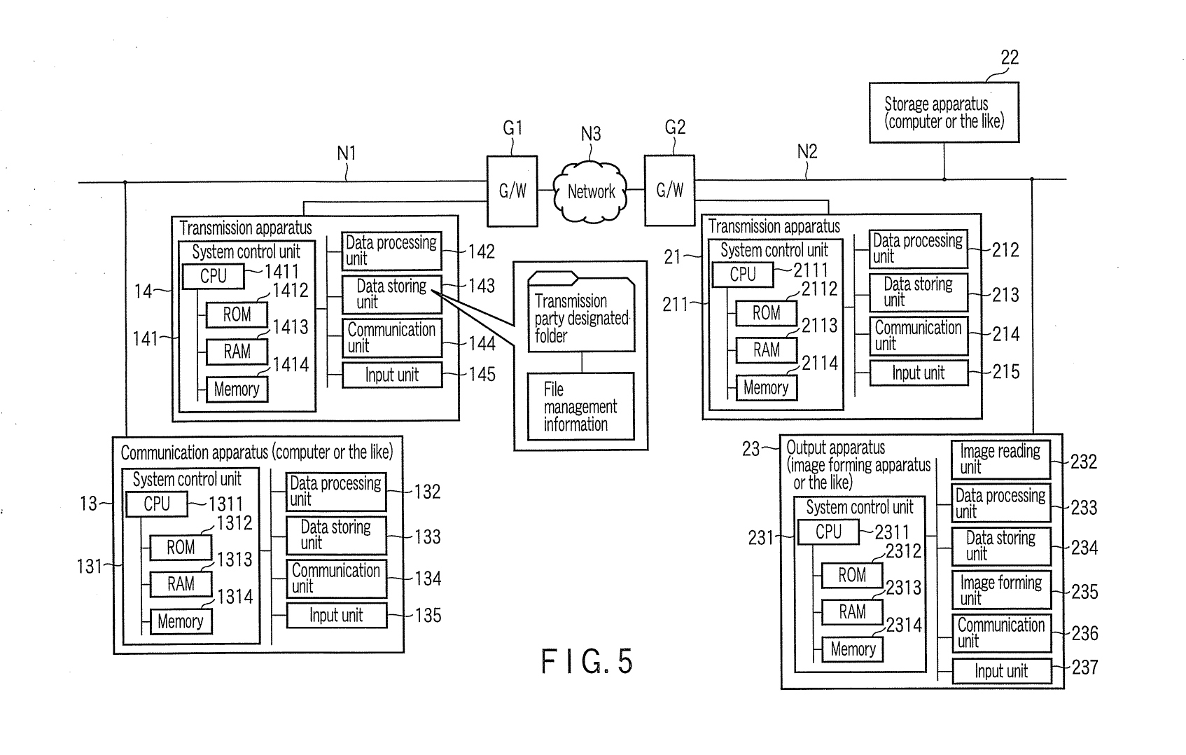

FIG. 5 is a diagram illustrating an example of the overall configurations of the communication apparatus 13, the transmission apparatus 14, the transmission apparatus 21, and the output apparatus 23 of the file transmission system according to the first embodiment.

As shown in FIG. 5, the communication apparatus 13 includes a system control unit 131, a data processing unit 132, a data storing unit 133, a communication unit 134, and an input unit 135. The system control unit 131 includes a CPU 1311, a ROM 1312, a RAM 1313, and a memory 1314. The CPU 1311 controls various kinds of processes related to the transmission and reception of files.

The transmission apparatus 14 includes a system control unit 141, a data processing unit 142, a data storing unit 143, a communication unit 144, and an input unit 145. The system control unit 141 includes a CPU 1411, a ROM 1412, a RAM 1413, and a memory 1414. The CPU 1411 controls various kinds of processes related to the transmission and reception of files.

Likewise, the transmission apparatus 21 includes a system control unit 211, a data processing unit 212, a data storing unit 213, a communication unit 214, and an input unit 215. The system control unit 211 includes a CPU 2111, a ROM 2112, a RAM 2113, and a memory 2114. The CPU 2111 controls various kinds of processes related to the transmission and reception of files.

The output apparatus 23 which is, for example, an image forming apparatus includes a system control unit 231, an image reading unit 232, a data processing unit 233, a data storing unit 234, an image forming unit 235, a communication unit 236, and an input unit (control panel) 237. The system control unit 231 includes a CPU 2311, a ROM 2312, a RAM 2313, and a memory 2314. The CPU 2311 controls various kinds of processes according to various kinds of inputs via the communication unit 236.

### First Embodiment

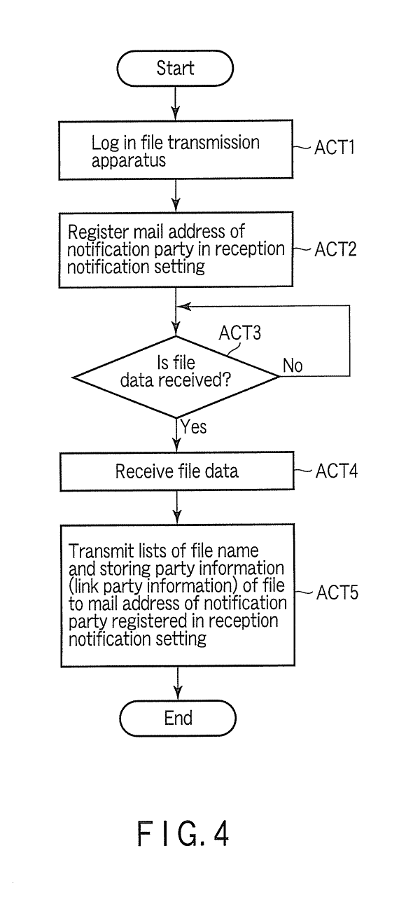

An example of a reception notifying process performed by the file transmission system according to a first embodiment will be described with reference to FIGS. 1, 4, and 5. FIG. 4 is a flowchart illustrating an example of the reception notifying process performed by the file transmission system according to the first embodiment.

For example, a user instructs access (log-in) to the transmission apparatus 14 through the input unit 135 of the communication apparatus 13. Then, the communication unit 134 of the communication apparatus 13 gains access (log-in) to the transmission apparatus 14 in response to the instruction (Act 1).

The user instructs setting (reception notification setting) of the notification party information (notification party mail address AAAAA) used to notify the transmission apparatus 14 of file reception via the input unit 135 of the communication apparatus 13. In response to the setting, the system control unit 141 of the transmission apparatus 14 manages (registers) the notification party information (Act 2). For example, the system control unit 141 stores (registers) file management information including the notification party information in the data storing unit 143.

The system control unit 141 generates a transmission party designated folder in the data storing unit 143 and processes the file stored in the transmission party designated folder based on the file management information or processes the reception notifying process. The file management information includes the notification party information and the file transmission party information. For example, the file transmission party information includes the telephone number of a file transmission party and the address of the file transmission party.

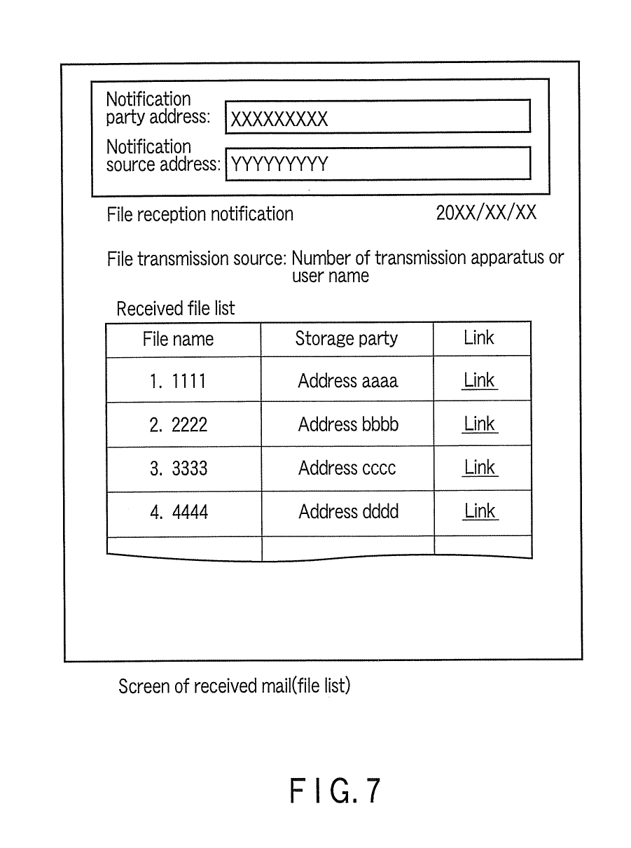

Above describes a case in which the transmission apparatus 14 receives one file, processes the one file, and gives a notification of the processing result of the one file. However, the transmission apparatus 14 may also receive a plurality of files in correspondence with a single file transmission operation, may process each of the plurality of files, and may give a notification of each of the processing results of the plurality of files. A notification example of the processing result is shown in, for example, FIG. 7.

Next, a file storing process and a reception notifying process corresponding to the file storing process will be described.

For example, a user selects a file stored in the data storing unit 133 through the input unit 135 of the communication apparatus 13, gives an instruction to process (for example, storing a file or storing a file in the storage apparatus 22) the selected file, and gives an instruction to transmit the selected file to the transmission party designated folder of the data storing unit 143 of the transmission apparatus 14. In response to this, the communication unit 134 of the communication apparatus 13 transmits the selected file and the file control information (for example, file control information used to give an instruction to store the file or file control information used to give an instruction to store the file in the storage apparatus 22) to the transmission apparatus 14.

The communication unit 144 of the transmission apparatus 14 receives the selected file and the file control information attached to the selected file (Act 3 and Act 4). Then, the system control unit 141 stores the selected file and the file control information attached to the selected file (hereinafter, referred to as a received file) in the transmission party designated folder of the data storing unit 143. The system control unit 141 processes the received file based on the file control information attached to the received file and the file management information stored in the data storing unit 143.

For example, the system control unit 141 transmits the received file and the file control information to the storage apparatus 22 through the transmission apparatus 21 based on the file control information (for example, the file control information used to give an instruction to store the file) attached to the received file and the transmission party information (for example, the transmission party information shown in the storage apparatus 22) included in the file management information. The storage apparatus 22 receives the received file and the file control information and stores the received file based on the file control information (the file control information used to give an instruction to store the file).

Alternatively, the system control unit 141 transmits the received file and the file control information through the transmission apparatus 21 to the storage apparatus 22 based on the file control information (for example, the file control information used to instruct the storage apparatus 22 to store the file) attached to the received file. The storage apparatus 22 receives the received file and the file control information and stores the received file based on the file control information (the file control information used to give an instruction to store the file).

The system control unit 141 gives a notification of the processing result of the received file based on the notification party information (the notification party mail address AAAA) included in the file management information. For example, the communication unit 144 transmits a received file list including the file name of the received file and the processing result (the storing of the file in the storage apparatus 22) of the received file to the notification party mail address AAAAA based on the notification party information (the notification party mail address AAAAA) (Act 5).

In the above description, the received file is stored, and then the system control unit 141 and the communication unit 144 give the notification of the processing result (storing) of the received file base on the notification party information. However, the system control unit 141 and the communication unit 144 may give the notification of the processing result (storing) of the received file based on the notification party information before the received file is stored. That is, the communication unit 144 may give the notification of the processing result of the received file at any timing, after receiving the received file and the file control information attached to the received file.

In the above description, the storage apparatus 22 stores the received file. However, the transmission apparatus 14 may store the received file based on the file control information. In the above description, the communication apparatus 13 and the transmission apparatus 14 are separate apparatuses. However, the communication apparatus 13 and the transmission apparatus 14 may not be separate apparatuses, but may be configured to be included in a multifunction transmission apparatus. In the above description, the transmission apparatus 21 and the storage apparatus 22 are separate apparatuses. However, the transmission apparatus 21 and the storage apparatus 22 may not be separate apparatuses, but may be configured to be included in a multifunction transmission apparatus. The multifunction transmission apparatus receives the received file and the file control information and stores the received file. In the above description, the transmission apparatus 14 has no image processing function. However, the transmission apparatus 14 may have an image processing function. That is, the transmission apparatus 14 may have the configuration of the output apparatus 23. In this case, for example, the transmission apparatus 14 reads an image from an original document, stores a file corresponding to the read image in the transmission party designated folder, transmits the file stored in the transmission party designated folder, and gives the notification of the processing result of the file (for example, the storing of the file in the storage apparatus 22) based on the notification party information.

Next, a file printing process and a reception notifying process corresponding to the printing process will be described.

For example, a user selects a file stored in the data storing unit 133 through the input unit 135 of the communication apparatus 13, gives an instruction to process (for example, to print or allow the output apparatus 23 to print) the selected file, and gives an instruction to transmit the selected file to the transmission party designated folder of the data storing unit 143 of the transmission apparatus 14. In response to the instruction the communication unit 134 of the communication apparatus 13 transmits the selected file and the file control information (for example, the file control information used to give an instruction to print the file or the file control information used to instruct the output apparatus 23 to print the file) to the transmission apparatus 14.

The communication unit 144 of the transmission apparatus 14 receives the selected file and the file control information attached to the selected file. Then, the system control unit 141 stores the selected file and the file control information attached to the selected file (hereinafter, referred to as a received file) in the transmission party designated folder of the data storing unit 143. The system control unit 141 processes the received file based on the file control information attached to the received file and the file management information stored in the data storing unit 143.

For example, the system control unit 141 transmits the received file and the file control information to the output apparatus 23 through the transmission apparatus 21 based on the file control information (for example, the file control information used to give an instruction to print the file) attached to the received file and the transmission party information (for example, the transmission party information which indicates the output apparatus 23) included in the file management information. The output apparatus 23 receives the received file and the file control information and prints the received file based on the file control information (the file control information used to give an instruction to print the file).

Alternatively, the system control unit 141 transmits the received file and the file control information to the output apparatus 23 through the transmission apparatus 21 based on the file control information (for example, the file control information used to instruct the printing apparatus 23 to print the file) attached to the received file. The output apparatus 23 receives the received file and the file control information and prints the received file based on the file control information (the file control information used to give an instruction to print the file).

The system control unit 141 gives a notification of the processing result of the received file based on the notification party information (the notification party mail address AAAAA) included in the file management information. For example, the communication unit 144 transmits a received file list including the file name of the received file and the processing result of the received file (the printing of the file in the output apparatus 23) to the notification party mail address AAAAA based on the notification party information (the notification party mail address AAAAA).

In the above description, the received file is printed, and then the system control unit 141 and the communication unit 144 give the notification of the processing result (printing) of the received file base on the notification party information. However, the system control unit 141 and the communication unit 144 may give the notification of the processing result (printing) of the received file based on the notification party information before the received file is printed. That is, the communication unit 144 may give the notification of the processing result of the received file at any timing, after receiving the received file and the file control information attached to the received file.

Moreover, in the above description, the storing and the printing are processed as separate processes, but may be processed as a series of processes. Next, a reception notifying process corresponding to the storing and printing processes will be described.

For example, a user selects a file stored in the data storing unit 133 through the input unit 135 of the communication apparatus 13, gives an instruction to process (for example, to store and print or allow the output apparatus 23 to store and print) the selected file, and gives an instruction to transmit the selected file to the transmission party designated folder of the data storing unit 143 of the transmission apparatus 14. In response to the instruction the communication unit 134 of the communication apparatus 13 transmits the selected file and the file control information (for example, the file control information used to give an instruction to store and print the file or the file control information used to instruct the output apparatus 23 to store and print the file) to the transmission apparatus 14.

The communication unit 144 of the transmission apparatus 14 receives the selected file and the file control information attached to the selected file. Then, the system control unit 141 stores the selected file and the file control information attached to the selected file (hereinafter, referred to as a received file) in the transmission party designated folder of the data storing unit 143. The system control unit 141 processes the received file based on the file control information attached to the received file and the file management information stored in the data storing unit 143.

For example, the system control unit 141 transmits the received file and the file control information to the output apparatus 23 through the transmission apparatus 21 based on the file control information (for example, the file control information used to give an instruction to store and print the file) attached to the received file and the transmission party information (for example, the transmission party information shown in the output apparatus 23) included in the file management information. The output apparatus 23 receives the received file and the file control information, and then stores and prints the received file based on the file control information (the file control information used to give an instruction to store and print the file).

Alternatively, the system control unit 141 transmits the received file and the file control information through the transmission apparatus 21 to the printing apparatus 23 based on the file control information (for example, the file control information used to instruct the printing apparatus 23 to store and print the file) attached to the received file. The output apparatus 23 receives the received file and the file control information, and then stores and prints the received file based on the file control information (the file control information used to give an instruction to store and print file).

The system control unit 141 gives a notification of the processing result of the received file based on the notification party information (the notification party mail address AAAAA) included in the file management information. For example, the communication unit 144 transmits a received file list including the file name of the received file and the processing result (the storing and printing of the file in the output apparatus 23) of the received file to the notification party mail address AAAAA based on the notification party information (the notification party mail address AAAAA).

In the above description, the received file is stored and printed, and then the system control unit 141 and the communication unit 144 give the notification of the processing result (storing+printing) of the received file based on the notification party information. However, the system control unit 141 and the communication unit 144 may give the notification of the processing result (storing+printing) of the received file based on the notification party information before the received file is stored and printed. That is, the communication unit 144 may give the notification of the processing result of the received file at any timing, after receiving the received file and the file control information attached to the received file.

In the above description, the output apparatus 23 prints the received file. However, the transmission apparatus 14 may have an image processing function and may print the received file based on the file control information. In the above description, the communication apparatus 13 and the transmission apparatus 14 are separate apparatuses. However, the communication apparatus 13 and the transmission apparatus 14 may not be separate apparatuses, but may be configured to be included in a multifunction transmission apparatus. In the above description, the transmission apparatus 21 and the output apparatus 23 are separate apparatuses. However, the transmission apparatus 21 and the output apparatus 23 may not be separate apparatuses, but may be configured to be included in a multifunction transmission apparatus. The multifunction transmission apparatus receives the received file and the file control information and prints the received file. In the above description, the transmission apparatus 14 has no image processing function. However, the transmission apparatus 14 may have an image processing function. That is, the transmission apparatus 14 may have the configuration of the output apparatus 23. In this case, for example, the transmission apparatus 14 reads an image from an original document, stores a file corresponding to the read image in the transmission party designated folder, transmits the file stored in the transmission party designated folder, and gives the notification of the processing result of the file (for example, the printing of the file in the output apparatus 23) based on the notification party information.

Above describes a case in which the transmission apparatus 14 receives one file, processes the one file, and gives a notification of the processing result of the one file. However, the transmission apparatus 14 may also receive a plurality of files in correspondence with a single file transmission operation, may process each of the plurality of files, and may give a notification of each of the processing results of the plurality of files. A notification example of the processing result is shown in, for example, FIG. 7.

### Second Embodiment

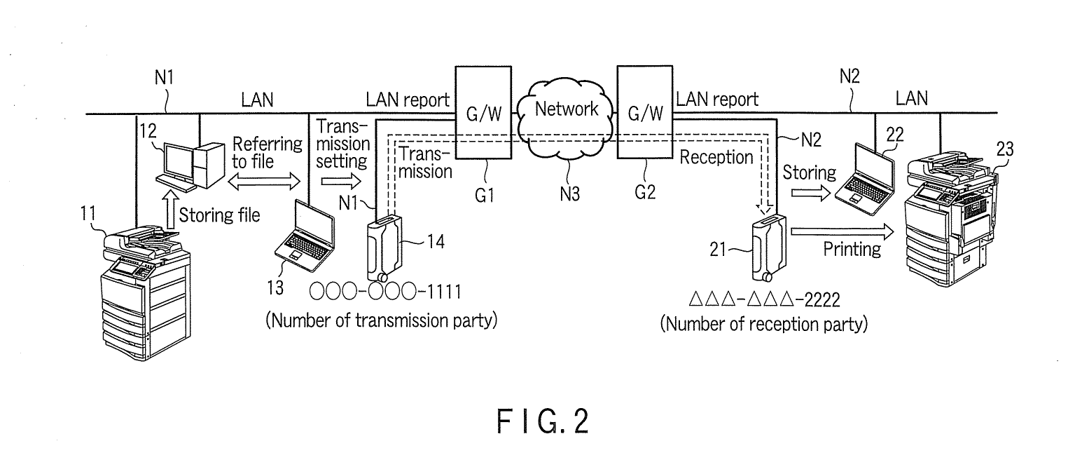

An example of a reception notifying process performed by a file transmission system according to a second embodiment will be described with reference to FIG. 2. In the second embodiment, description will mainly be made on the differences from the first embodiment, and the description of the similar parts with those of the first embodiment will not be repeated.

As shown in FIG. 2, the file transmission system includes an image forming apparatus 11, a computer 12, the communication apparatus 13, the transmission apparatus 14, the transmission apparatus 21, the storage apparatus 22, and the output apparatus 23. The image forming apparatus 11 have substantially the same configuration as that of the output apparatus 23, and the detailed description thereof will not be repeated. The computer 12 has substantially the same configuration of that of the communication apparatus 13, and the detailed description thereof will not be repeated. The communication apparatus 13, the transmission apparatus 14, the transmission apparatus 21, the storage apparatus 22, and the output apparatus 23 have the configurations as described above, and the detailed description thereof will not be repeated.

The image forming apparatus 11, the computer 12, the communication apparatus 13, and the transmission apparatus 14 are connected to each other via the first network N1 and the transmission apparatus 21, the storage apparatus 22, and the output apparatus 23 are connected to each other via the second network N2. The first network N1 and the second network N2 are connected to each other via various types of communication devices. For example, the first network N1 and the second network N2 are connected to each other via the gateway G1, the third network N3, and the gateway G2.

An image reading unit of the image forming apparatus 11 reads an image from an original document, a data storing unit of the image forming apparatus 11 stores a file corresponding to the read image, and a communication unit of the image forming apparatus 11 transmits the file to the computer 12. The computer 12 stores the transmitted file.

A user selects the file stored in the data storing unit 133 through the input unit 135 of the communication apparatus 13, gives an instruction to process the selected file (for example, to store the file, to store the file in the storage apparatus 22, to print the file, to allow the output apparatus 23 to print the file, to store and print the file, or to allow the output apparatus 23 to store and print the file), and gives an instruction to transmit the selected file to the transmission party designated folder of the data storing unit 143 of the transmission apparatus 14. Thereafter, the processes are the same as described in the first embodiment.

### Third Embodiment

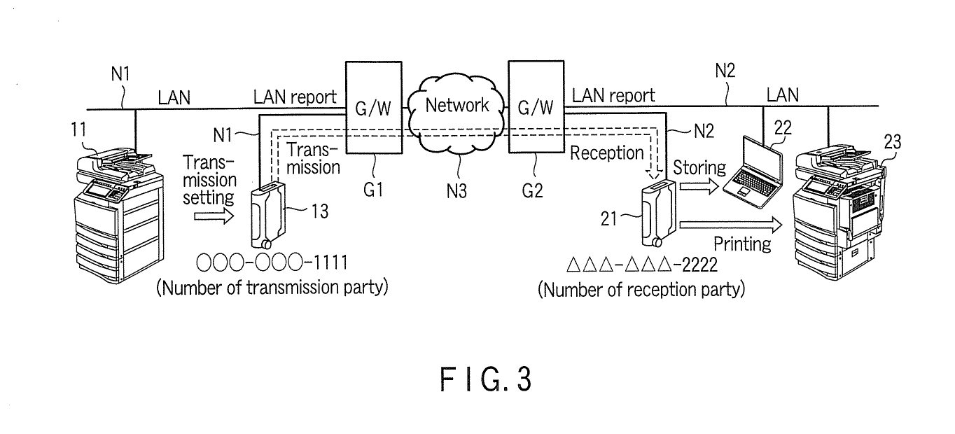

An example of a reception notifying process performed by a file transmission system according to a third embodiment will be described with reference to FIG. 3. In the third embodiment, description will mainly be made on the differences from the first embodiment, and the description of the similar parts with those of the first embodiment will not be repeated.

As shown in FIG. 3, the file transmission system includes an image forming apparatus 11, the transmission apparatus 14, the transmission apparatus 21, the storage apparatus 22, and the output apparatus 23. The image forming apparatus 11 has substantially the same configuration as that of the output apparatus 23, and the detailed description thereof will not be repeated. The transmission apparatus 14, the transmission apparatus 21, the storage apparatus 22, and the output apparatus 23 have the same configurations as described above, and the detailed description thereof will not be repeated.

The image forming apparatus 11 and the transmission apparatus 14 are connected to each other via the first network N1 and the transmission apparatus 21, the storage apparatus 22, and the output apparatus 23 are connected to each other via the second network N2. The first network N1 and the second network N2 are connected to each other via various types of communication devices. For example, the first network N1 and the second network N2 are connected to each other via the gateway G1, the third network N3, and the gateway G2.

The image reading unit of the image forming apparatus 11 reads an image from an original document and the data storing unit of the image forming apparatus 11 stores a file corresponding to the read image. A user selects the file stored in the data storing unit through an input unit (control panel) of the image reading apparatus 11, gives an instruction to process the selected file (for example, to store the file, to store the file in the storage apparatus 22, to print the file, to allow the output apparatus 23 to print the file, to store and print the file, or to allow the output apparatus 23 to store and print the file), and gives an instruction to transmit the selected file to the transmission party designated folder of the data storing unit 143 of the transmission apparatus 14. Thereafter, the processes are the same as described in the first embodiment.

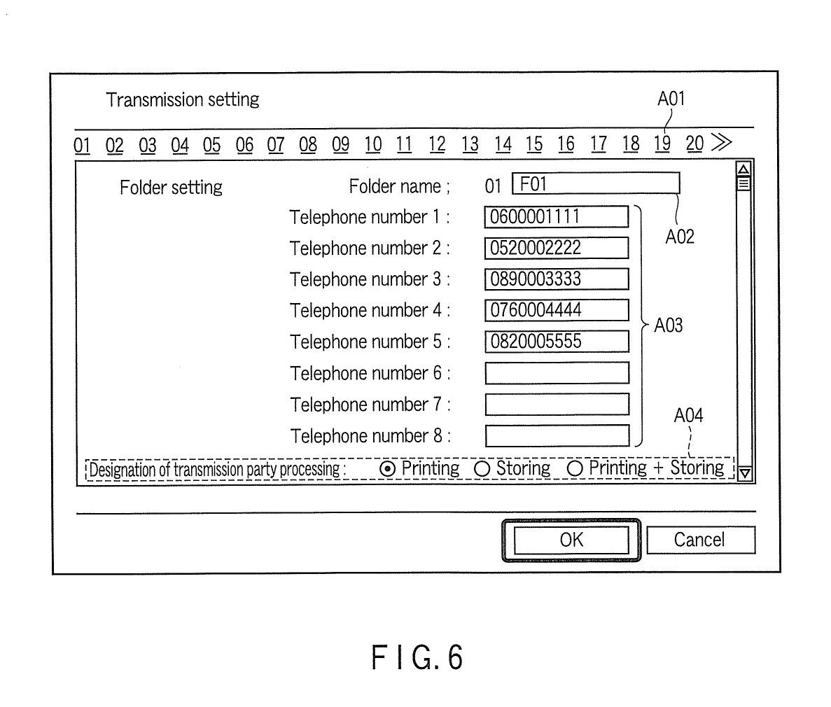

Next, an example of the setting of the above-described transmission party designated folder will be described. FIG. 6 is a diagram illustrating an example of a setting screen of the transmission party designated folder. For example, a user sets processing conditions of the file stored in the transmission party designated folder through a user interface of a user device such as the input unit (control panel) of the image forming apparatus 11 or an input unit of the communication apparatus 13.

The transmission apparatus 14 displays the setting screen shown in FIG. 6 on the user interface of the user device when receiving an instruction to generate a folder or to change a setting from the user device through the input unit 145 or the communication unit 144.

As shown in FIG. 6, the setting screen includes a folder selection area A01 used to select a folder to be generated or subjected to setting change. For example, in FIG. 6, a state where a folder F01 is selected is shown. The folder name of the folder F01 is input to an input area A02 of the folder F01. A transmission party corresponding to the above-described file transmission party information is input to an input area A03. The transmission party input to the input area A03 is set in relation to the selected folder F01.

The transmission apparatus 14 can receive a processing condition, which indicates how a transmitted file is processed in the transmission party, from the user device via the input unit 145 or the communication unit 144. For example, the transmission apparatus 14 can receive from the user device a processing condition indicating a priority order placed after the above-described file control information. That is, when a file for which the above-described file control information is set is stored in the transmission party designated folder, the file is processed based on the file control information. Moreover, when a file for which the above-described file control information is not set is stored in the transmission party designated folder, the file is processed based on the processing condition received here.

For example, the setting screen includes a processing condition designation area A04 of the transmission party. The processing condition designation area A04 of the transmission party includes “printing”, “storing”, and “storing+printing”. The processing condition designation area A04 of the transmission party is set for each folder. The transmission apparatus 14 transmits the file stored in the transmission party designated folder and the file control information attached to this file to the transmission party (for example, the output apparatus 23) based on the destination information set in the input area A03. Alternatively, the transmission apparatus 14 transmits the file stored in the transmission party designated folder and the processing condition designated in the processing condition designation area A04 of the transmission party to the transmission party (for example, the output apparatus 23) based on the destination information set in the input area A03.

The transmission party (for example, the output apparatus 23) receives the file and the file control information and processes the received file based on the received file control information. Alternatively, the transmission party (for example, the output apparatus 23) receives the file and the file control information and processes the received file based on the received processing condition.

When “printing” is included in the file control information or the processing condition, the transmission party (for example, the output apparatus 23) prints the received file. Alternatively, when “printing” is included in the file control information or the processing condition, the transmission party (for example, the output apparatus 23) transmits the received file to another output apparatus registered in advance as an apparatus performing printing.

When “storing” is included in the file control information or the processing condition, the transmission party (for example, the storage apparatus 22) stores the received file in a designated storage party (the storage apparatus 22).

When “storing+printing” is included in the file control information or the processing condition, the transmission party (for example, the output apparatus 23) stores the received file in a designated storage party and prints the file. Alternatively, when “storing+printing” is included in the file control information or the processing condition, the transmission party (for example, the output apparatus 23) stores the received file in a designated storage party and transmits the file to another output apparatus registered in advance as an apparatus performing printing.

Next, an example of a notification screen of the processing result of the above-described received file will be descried. FIG. 7 is a diagram illustrating an example of the notification screen of the processing result of a received file.

The system control unit 141 generates notification screen display information to display the notification screen indicating the processing result of the received file. The communication unit 144 transmits the notification screen display information based on notification party information (notification party address: XXXXXXXXX) included in the file management information. The communication terminal corresponding to the notification party address XXXXXXXXX can receive the notification screen display information and can display the notification screen shown in FIG. 7 based on the notification screen display information.

That is, the notification screen display information generated by the system control unit 141 and the notification screen displayed by the communication terminal include a notification party address (XXXXXXXXX), a notification source address (YYYYYYYYY), notification date information (2011 Jan. 1), file transmission source information (identification information (for example, a number or a user name) of the notification apparatus 13), and a reception file list (file name, storage party, and link part). The reception file list is a list of the files transmitted by a single file transmission operation. The link party in the reception file list may be omitted.

Now, the first, second, and third embodiments will be summarized.

The transmission apparatus (the file transmission system) according to the first, second, or third embodiment registers the mail address of an administrator or the mail address of a designated user in the reception notification setting in advance.

In response to the reception of a file, the transmission apparatus detects the file name and the storage party (the file link party) of the file from the information appended to the file and generates a list including the file name of the file and the storage party (the file link party) of the file. Then, the transmission apparatus transmits the list to the communication apparatus with the registered mail address. The transmission apparatus further transmits the file and the control information used to give the instruction to store the file to a storage apparatus of the file storage party.

The storage apparatus receives the file and the control information used to give the instruction to store the file, and store the file based on the control information.

The communication apparatus receives the list and displays the storage party (the file link party) of the file included in the file. When the displayed storage party is selected in response to the selection operation, the communication apparatus gains access to the file stored in the storage party (the storage apparatus), and then downloads the file or displays the file.

For example, the administrator can grasp the use frequency of the transmission apparatus, obtain the file, or monitor the details of the file from the list (mail) received by the communication apparatus without accessing to the transmission apparatus. Moreover, the user can confirm that the file is transmitted and the file is processed with reference to the list (mail) received by the communication apparatus and can easily gain access to the file, obtain the file, or view the details of the file from the information of the file storage party included in the list.

Alternatively, in response to the reception of the file, the transmission apparatus detects the file name and the printing of the file by the output apparatus from the information appended to the file and generates a list including the file name and the printing of the file by the output apparatus. Then, the transmission apparatus transmits the list to the communication apparatus with the registered mail address. The transmission apparatus further transmits the file and the control information used to give the instruction to print the file to the output apparatus.

The printing apparatus receives the file and the control information used to give the instruction to print the file and prints the file based on the control information.

The communication apparatus receives the list and displays the information included in the list. That is, the communication apparatus displays that the output apparatus prints the file. The user can know from the list that the output apparatus prints the file.

As described above, the transmission apparatus (the file transmission system) according to the first, second, or third embodiment can simply give a notice of the file processing state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reception notifying apparatus comprising:
a management unit that manages notification party information used to give a notification of file reception;
a reception unit that receives a file;
a processing unit that processes the received file based on file control information attached to the received file; and
a notification unit that gives a notification of the processing result of the received file based on the notification party information.

2. The apparatus according to claim 1,
wherein the processing unit stores the received file based on a file storing instruction included in the file control information, and
wherein the notification unit gives a notification of the processing result indicating that the received file is stored based on the notification party information.

3. The apparatus according to claim 1,
wherein the processing unit transmits the received file to a file storing apparatus and stores the received file in the file storing apparatus based on an instruction, which is included in the file control information, to store the received file in the file storing apparatus, and
wherein the notification unit gives a notification of the processing result indicating that the received file is stored in the file storing apparatus based on the notification party information.

4. The apparatus according to claim 3,
wherein the management unit manages a mail address used to give the notification of file reception, and
wherein the notification unit transmits a received file list including a file name of the received file and the processing result toward the mail address.

5. The apparatus according to claim 4,
wherein the reception unit receives a plurality of files,
wherein the processing unit processes each received file based on each file control information attached to each received file, and
wherein the notification unit transmits display information to screen-display a received file list including a file name of each received file and the processing result of each received file to the mail address.

6. The apparatus according to claim 1,
wherein the processing unit prints the received file based on a file printing instruction included in the file control information, and
wherein the notification unit gives a notification of the processing result indicating that the received file is printed based on the notification party information.

7. The apparatus according to claim 1,
wherein the processing unit transmits the received file to a file printing apparatus and instructs the file printing apparatus to print the received file based on a printing instruction, which is included in the file control information, to allow the file printing apparatus to print the received file, and
wherein the notification unit gives a notification of the processing result indicating that the received file is printed by the file printing apparatus based on the notification party information.

8. The apparatus according to claim 7,
wherein the management unit manages a mail address used to give the notification of file reception, and
wherein the notification unit transmits a received file list including a file name of the received file and the processing result toward the mail address.

9. A reception notifying method comprising:
managing notification party information used to give a notification of file reception;
receiving a file;
processing the received file based on file control information attached to the received file; and
giving a notification of the processing result of the received file based on the notification party information.

10. The method according to claim 9, further comprising:
storing the received file based on a file storing instruction included in the file control information; and
giving a notification of the processing result indicating that the received file is stored based on the notification party information.

11. The method according to claim 9, further comprising:
transmitting the received file to a file storing apparatus and stores the received file in the file storing apparatus based on an instruction, which is included in the file control information, to store the received file in the file storing apparatus; and
giving a notification of the processing result indicating that the received file is stored in the file storing apparatus based on the notification party information.

12. The method according to claim 11, further comprising:
managing a mail address used to give the notification of file reception; and
transmitting a received file list including a file name of the received file and the processing result toward the mail address.

13. The method according to claim 9, further comprising:
printing the received file based on a file printing instruction included in the file control information; and
giving a notification of the processing result indicting that the received file is printed based on the notification party information.

14. The method according to claim 9, further comprising:
transmitting the received file to a file printing apparatus and instructing the file printing apparatus to print the received file based on a printing instruction, which is included in the file control information, to allow the file printing apparatus to print the received file; and
giving a notification of the processing result indicating that the received file is printed by the file printing apparatus based on the notification party information.

15. The method according to claim 14, further comprising:
managing a mail address used to give the notification of file reception; and
transmitting a received file list including a file name of the received file and the processing result toward the mail address.

16. A reception notifying apparatus comprising:
management means for managing notification party information used to give a notification of file reception;
reception means for receiving a file;
processing means for processing the received file based on file control information attached to the received file; and
notification means for giving a notification of the processing result of the received file based on the notification party information.

17. The apparatus according to claim 16,
wherein the processing means stores the received file based on a file storing instruction included in the file control information, and
wherein the notification means gives a notification of the processing result indicating that the received file is stored based on the notification party information.

18. The apparatus according to claim 16,
wherein the processing means transmits the received file to a file storing apparatus and stores the received file in the file storing apparatus based on an instruction, which is included in the file control information, to store the received file in the file storing apparatus, and
wherein the notification means gives a notification of the processing result indicating that the received file is stored in the file storing apparatus based on the notification party information.

19. The apparatus according to claim 16,
wherein the processing means prints the received file based on a file printing instruction included in the file control information, and
wherein the notification means gives a notification of the processing result indicating that the received file is printed based on the notification party information.

20. The apparatus according to claim 16,
wherein the processing means transmits the received file to a file printing apparatus and instructs the file printing apparatus to print the received file based on a printing instruction, which is included in the file control information, to allow the file printing apparatus to print the received file, and
wherein the notification means gives a notification of the processing result indicating that the received file is printed by the file printing apparatus based on the notification party information.
